(19) United States
(12) Patent Application Publication
(10) Pub. No.: US 2009/0261222 A1
(43) Pub. Date: Oct. 22, 2009

(54) CONNECTION SOCKET OF AN EXERCISE APPARATUS

(76) Inventor: Leao Wang, Taichung (TW)

Correspondence Address: Leao Wang, 13F, No. 23, Jiun-Ho Street, Beitun District, Taichung, 406, omitted

(21) Appl. No.: 12/107,067

(22) Filed: Apr. 21, 2008

(51) Int. Cl. A47F 5/00

(52) U.S. Cl. 248/314

(57) ABSTRACT

A connection socket of an exercise apparatus having a base and a swivel seat. The base has a support face with a plurality of through holes for connection of an electronic control panel. A soft pad is adhered to the support face. Moreover, the swivel seat includes an upper cover, a connector unit and a lower cover. After assembly, the swivel seat is pivotally attached to a cavity of the base in such a way that the connection pins of the connector unit are extended out of the upper cover. In this way, the swivel seat can be properly swiveled such that a problemfree insertion of the portable player or the cellular phone in different dimensions and thickness is ensured.

### BACKGROUND OF THE INVENTION

1. Fields of the Invention

The invention relates to a connection socket of an exercise apparatus for a portable mini electric device, and more particularly, to a structure intended to hold a portable player or a cellular phone in different size and thickness. A loudspeaker and a microphone built within the exercise apparatus can be employed for a practical audio/video output or an easy telephony connection.

2. Description of the Related Art

The portable players (such as MP3, MP4, etc.) or cellular phones have become indispensable for the modern people. People who take exercise with the indoor fitness apparatus hope that their portable players can be directly connected to the fitness apparatus or the accessories of the cellular phone. As a result, the operator can play his favorite music, film or make telephony connections by himself such that the exercise apparatus can meet the personal requirements of different operators.

Of course, such a connection socket having built-in loudspeaker and microphone has been provided in many fitness apparatuses in the market so that the above-mentioned important requirements can be fulfilled . . . . However, only special portable players or cellular phones with certain brands, models, specifications are applicable without problem due to the design mistake of the structure of the connection socket. Therefore, the conventional connection socket cannot be used by all operators.

The above-mentioned problem lies in that the insertion head and the receptacle portion of the connection socket of an exercise apparatus have fixed and not adjustable dimensions. Therefore, a smooth insertion is hindered and this requires further improvements.

### SUMMARY OF THE INVENTION

An object of the invention is to provide a connection socket of an exercise apparatus in which a connector unit is installed in a swivel seat such that the swivel seat can be properly swiveled within a base, thereby creating a sufficient space for a smooth insertion of the portable player and the cellular phone having different dimensions and thickness. In this way, the application scope can be effectively enhanced.

According to the invention, a connection socket of an exercise apparatus in accordance with the invention includes a base and a swivel seat. The base has a support face with a plurality of through holes for connection of an electronic control panel. A soft pad is adhered to the support face. Moreover, the swivel seat includes an upper cover, a connector unit and a lower cover. After assembly, the swivel seat is pivotally attached to a cavity of the base in such a way that the connection pins of the connector unit are extended out of the upper cover. In this way, the swivel seat can be properly swiveled such that a problemfree insertion of the portable player or the cellular phone in different dimensions and thickness is ensured.

### BRIEF DESCRIPTION OF THE DRAWINGS

The accomplishment of this and other objects of the invention will become apparent from the following description and its accompanying drawings of which:

FIG. 1 is an exploded perspective view of a connection socket in accordance with the invention;

FIG. 2 is a perspective assembly view of a connection socket in accordance with the invention;

FIG. 3 is a schematic drawing of the invention applied to a fitness apparatus; and

FIG. 4 is a schematic drawing of the invention applied to another fitness apparatus.

### DETAILED DESCRIPTION OF THE PREFERRED EMBODIMENT

The present invention will now be described in more detail hereinafter with reference to the accompanying drawings that show various embodiments of the invention.

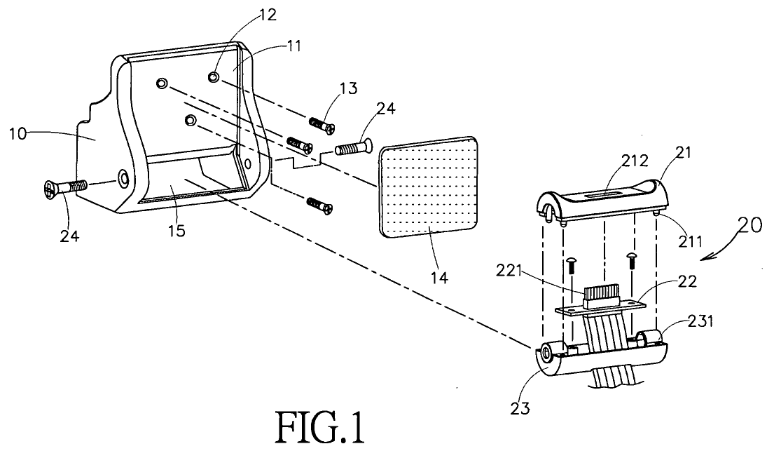

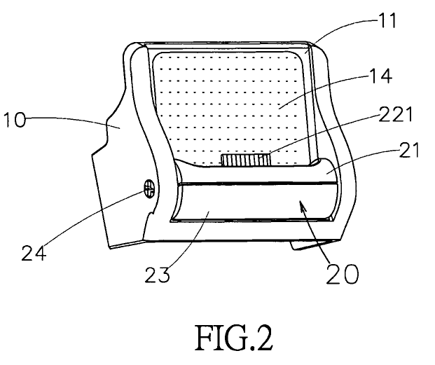

Referring to FIGS. 1 and 2, a connection socket in accordance with a first embodiment of the invention includes a base 10 and a swivel seat 20. The base 10 has a support face 11 with a plurality of through holes 12. An electronic control panel 30 is fixed by means that locking elements 13 are screwed into the through holes 12. A soft pad 14 is adhered to the support face 11. Moreover, the swivel seat 20 includes an upper cover 21, a connector unit 22 and a lower cover 23. After insertion pins 211 fit into corresponding insertion holes 231, the swivel seat 20 is pivotally attached by a pivot pin set 24 to a cavity 15 of the base 10 in such a way that the connection pins 221 of the connector unit 22 are extended out of a slot 212 of the upper cover 21. In this way, the swivel seat 20 can be properly swiveled such that a problemfree insertion of the portable player 40 or the cellular phone (not shown) in different dimensions and thickness is ensured.

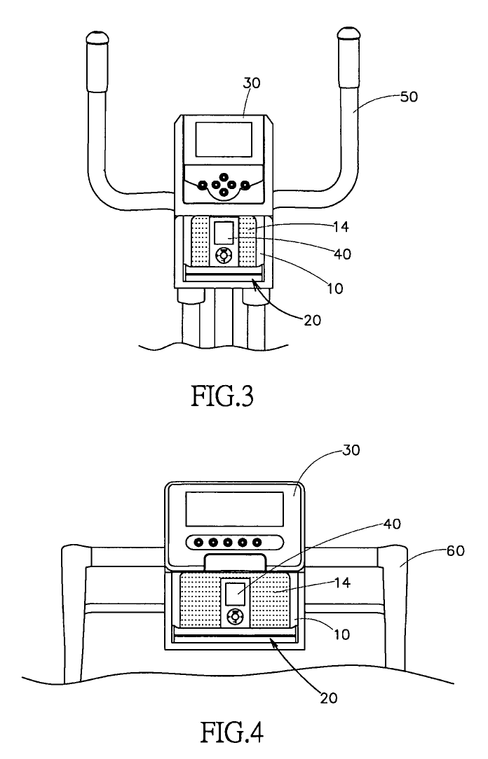

In use, the swivel seat 20 outwardly rotates on the pivot pin set 24 such that the connection pins 221 are far away from the support face 11 of the base 10. No matter how the dimensions and the thickness of the portable player 40 and the cellular phone are, a problemfree insertion of the portable player 40 and the cellular phone is guaranteed under the precondition that the connection pins 221 are suitable for their insertion. Thereafter, the portable player 40 or the cellular phone rotates together with the swivel seat 20 in direction of the support face 11 back to the original position. In this way, the portable player 40 and the cellular phone can stably lie on the soft pad 14, and the soft pad 14 provides a proper cushioning and protecting effect for the portable player 40 or the cellular phone. Referring to FIGS. 3 and 4, the connection socket in accordance with the invention can be installed without problem either on a small electronic control panel 30 of a fitness apparatus (not shown, or an elliptical cross trainer 50) or on a large electronic control panel 30 of a treadmill 60.

Of course, the connection pins 221 of the connector unit 22 have different forms for corresponding requirements when used or replaced. Meanwhile, they are suitable for certain female connector of the portable player 40 and the cellular phone with different brands and models.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A connection socket of an exercise apparatus having a base and a swivel seat, the base having a support face with a plurality of through holes, an electronic control panel being fixed by means that locking elements are screwed into the through holes, a soft pad being adhered to the support face, the swivel seat having an upper cover, a connector unit and a lower cover,
wherein, after insertion pins fit into corresponding insertion holes, the swivel seat is pivotally attached by a pivot pin set to a cavity of the base in such a way that the connection pins of the connector unit are extended out of a slot of the upper cover; in this way, the swivel seat can be properly swiveled such that a problemfree insertion of the portable player or the cellular phone in different dimensions and thickness is ensured.

2. The connection socket of an exercise apparatus as recited in claim 1, wherein the connection pins of the connector unit have different forms for corresponding requirements when used or replaced.
